(19) United States
(12) Patent Application Publication
(10) Pub. No.: US 2011/0066853 A1
(43) Pub. Date: Mar. 17, 2011

(54) SYSTEM AND METHOD FOR SECURELY IDENTIFYING AND AUTHENTICATING DEVICES IN A SYMMETRIC ENCRYPTION SYSTEM

(76) Inventors: Daniel Wayne Engels, Collyville, TX (US); Eric Myron Smith, Dallas, TX (US); Troy Allan Schultz, Cambridge (CA)

(21) Appl. No.: 12/779,496

(22) Filed: May 13, 2010

Related U.S. Application Data
(60) Provisional application No. 61/213,166, filed on May 13, 2009.

(51) Int. Cl. H04L 9/32; H04L 9/00

(52) U.S. Cl. 713/168; 380/259

(57) ABSTRACT

The present invention describes a system and method for securely identifying and authenticating devices in a symmetric encryption system. An RFID tag can generate indicators using encryption state variables and a symmetric key. An RFID reader, after receiving the encryption state variables from the tag, may identify the tag by performing an exhaustive key search in a key database. Each key in the database may be tested by using the key and encryption state variables to perform an encryption operation similar to that performed by the tag. The result is then compared with the received tag indicators to determine if the tag has been identified. A rotor-based encryption scheme provides for a low cost key search while providing resilience against cloning, tracking, tampering and replay attacks.

### CROSS-REFERENCE TO RELATED APPLICATIONS

This application claims the benefit of U.S. Provisional Application No. 61/213,166, entitled “System and Method for Securely Identifying and Authenticating Devices in a Symmetric Encryption System”, filed May 13, 2009, all of which is incorporated by reference herein.

### FIELD

The described embodiments generally relate to a system and method for securely identifying and authenticating devices in a symmetric encryption system, and more particularly, providing a secure identification method using a low cost efficient key search.

### BACKGROUND

Secure authentication over a communications channel is an important aspect of system security. When a communications channel is unsecured an adversary may be able to intercept communications and impersonate another party. Robust authentication protocols must be developed that can withstand replay, cloning, and other attacks from an adversary who may intercept, modify, or interject communications.

Securing communication between low resource devices is particularly problematic due to the extreme power, memory and size limitations imposed upon these devices, especially passive RFID tags. These constraints mean that the devices must employ lightweight cryptography that is secure enough to withstand attacks while being efficient enough to fit within the limitations and constraints of the devices, particularly devices with extreme constraints such as passive UHF RFID tags. Most security proposals have either been proven to be easily exploitable, impractical, or have required too much size, time, or computational power for the most constrained devices. In addition, these proposals usually cannot be integrated into the established RFID standards, such as the EPCglobal Gen 2 Standard, without modifications to the standards.

Secure communication typically requires two basic functions to be performed at the beginning of the communication process: identification of one or more of the communicating parties and authentication that the parties are who they claim to be. Identification in low resource wireless devices is traditionally performed either manually such that a human is involved in the process or is performed without security in the communication of the identities. Authentication, in this case, is performed typically through the use of a challenge-response protocol after the identification step.

Performing identification without security poses security and privacy risks. For example, if an RFID tag carried by an individual broadcasts its identification information, the individual's location may be tracked. If there is not security on the identification information it is also easier to clone the device or perform replay attacks.

Challenge-response authentication protocols that have not already performed an identification step typically require a large key search that scales at worst linearly with the number of keys in the database to identify the communicating party. Binary tree search protocols address the key search issue in that the cost of the search scales logarithmically with the number of keys. However, binary tree search approaches require the tag to store O(Log N) keys and also requires O(Log N) rounds of communication. Moreover, a compromise of the keys in a few tags may destroy the security of the whole system.

Synchronized approaches avoid the cost of an extensive key search since a simple table look-up is often all that is needed to identify the tag. The downside is that if the tag and the reader should ever become unsynchronized, either by surreptitious means or a hardware, communications, or other failure, then the system must fall back to an exhaustive key search.

Most encryption schemes use block ciphers that operate on multiple words and are computationally intensive. With block ciphers the receiver must wait for the entire block to be received before the algorithm may begin, adding further delay to the encryption and authentication process.

### SUMMARY

In a first aspect, some embodiments provide a system and method of securely identifying and authenticating communications between a first device and a second device in a symmetric encryption system, each device having encryption state variables. The second device receives encryption state variables from the first device. For each key in a key database of the second device, the second device generates an indicator using the encryption state variables and the encryption key and then compares the generated indicator to an indicator received from the first device in order to identify the first device by the encryption key used to generate the indicator. In another aspect, some embodiments determine if the received encryption state variables relate to an encryption key in the key database of the second device to assist in identifying the first device.

In another aspect, some embodiments of the system and method may provide a challenge command to the first device in order to validate the response of the first device. The second device will generate the challenge command and then encrypt the command using the encryption state variables. A second indicator may be generated by encrypting the current state of the encryption state variables. The challenge command and second indicator are then transmitted to the first device. In some embodiments, the first device will receive the challenge command and will encrypt the challenge command. The first device will validate the second device if the received second indicator matches an indicator generated at the first device using the encryption state variables. The first device may now generate a third indicator that may be used by the second device to validate the first device if the indicator generated by the second device matches the third indicator transmitted by the first device.

In another aspect, some embodiments of the provide for a system for securely authenticating communications in a symmetric encryption system. A first device, having encryption state variables, comprises a transmitter for transmitting encryption state variables and indicators. The second device, having encryption state variables, comprises a receiver for receiving encryption state variables; a key database for storing encryption keys; encryption logic for generating indicators using the received encryption state variables and encryption key from the key database; and processing logic for comparing generated indicator values to received indicator values to identify the first device by the encryption key used. In still another aspect, in some embodiments of the system the processing logic of the second device may determine if the received encryption state variables relate to an encryption key within the key database. In another aspect, the first device may be further comprised of initialization logic for generating an initialization vector in response to a query and initializing the encryption state variables; and encryption logic for generating indicator values using the encryption state variables.

In another aspect, some embodiments provide a system and method for securely identifying and authenticating communications between a first device and a second device in a symmetric encryption system, by first, providing secure identification from the first device to the second device, and second, providing secure authentication between the first device and the second device. The secure identification may be provided by generating an indicator using encryption state variables of the first device; transmitting the encryption state variables and the indicator to the second device; an at the second device, for each encryption key in a key database, comparing an indicator generated using the encryption key and the received encryption state variables to the indicator received from the first device. In another aspect, the system and method may be integrated within RFID standards, such as the EPCGlobal Gen 2 standard, by providing the secure identification information as part of the known RFID standard.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 shows an embodiment of the system for providing secure communication and authentication between a first device and a second device;

FIG. 2 shows a protocol diagram of a synchronous embodiment;

FIG. 3 shows a process flow of a synchronous embodiment;

FIG. 4 shown is a protocol diagram of a non-synchronous embodiment;

FIG. 5 shows a process flow of a non-synchronous embodiment;

FIG. 6 shows an implementation of an unsecure identification protocol; and

FIG. 7 shows an embodiment integrated within a common RFID protocol.

### DESCRIPTION OF EXEMPLARY EMBODIMENTS

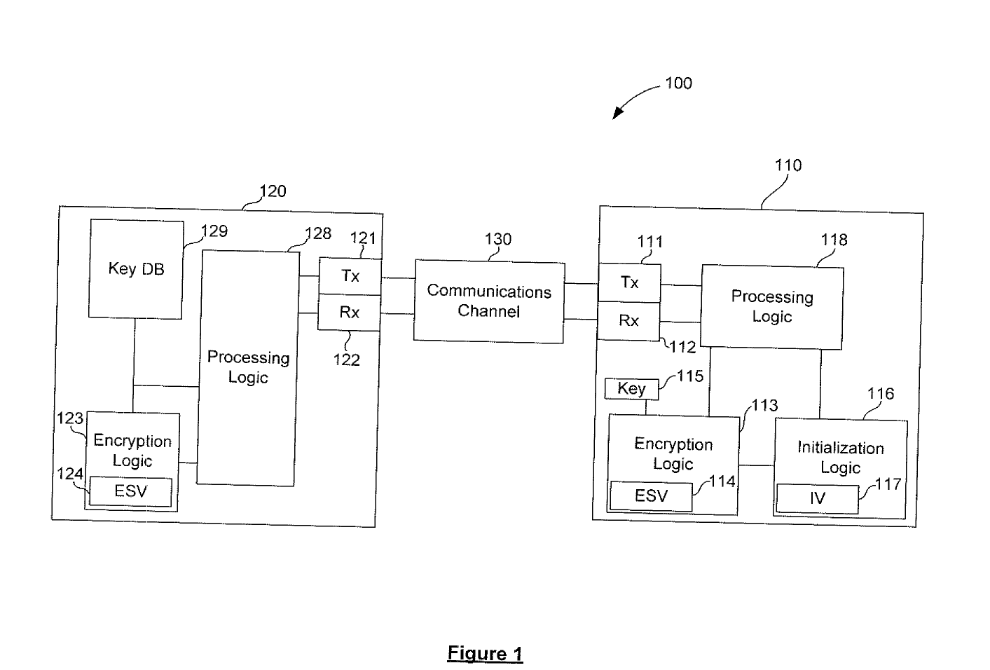

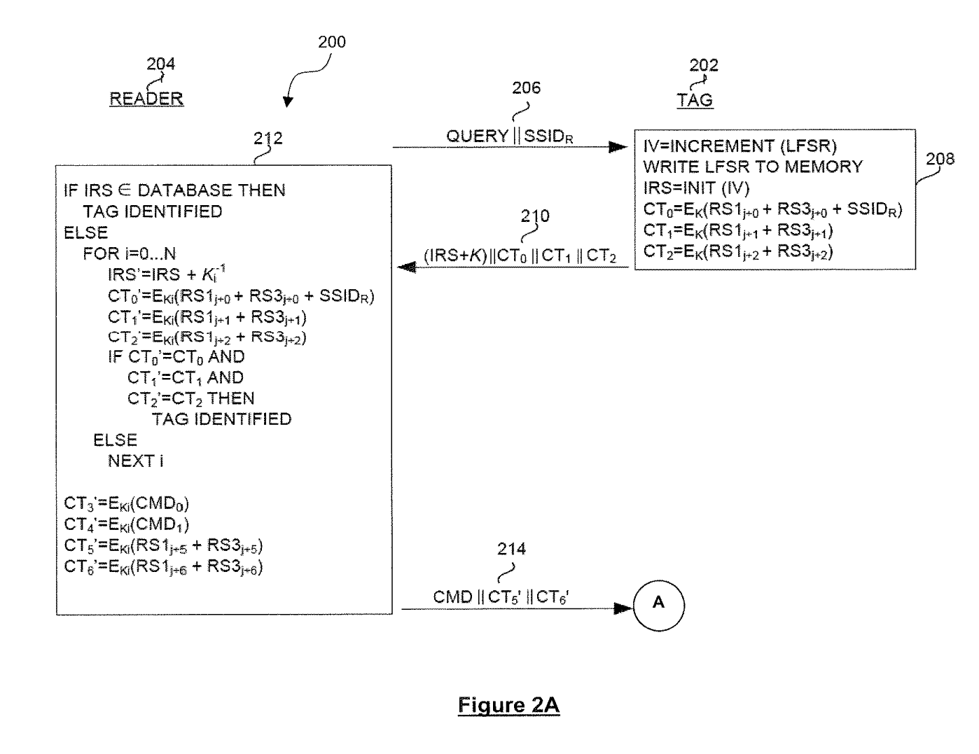

Reference is first made to FIG. 1, shown is a system 100 for providing secure communication and authentication between a first device 110 and a second device 120 communicating over communication channel 130. The first device 110 and second device 120 have transmitters 111, 121 and receivers 112, 122 for communicating over the communication channel 130. In some embodiments, the first device may be an RFID tag and the second device may be an RFID tag reader.

The communication channel may be wired or wireless and could include communication channels over other networks such as the internet or cell phone networks. The devices may be any type of device capable of communicating over the communication channel. While the example of an RFID tag and reader are used throughout the description, the teachings described herein may be applied to any number of communication devices and networks, for example cell phones, Internet appliances, Bluetooth™ devices or WiFI devices.

The first device 110 contains encryption logic 113 that implements an encryption algorithm using the encryption state variables 114. The first device 110 also has an encryption key 115 that is used in the symmetric encryption algorithm implemented by the encryption logic 113. The encryption logic will use the symmetric encryption key 115 and the encryption state variables 114 when encrypting plain text. In order to communicate with the first device 110, the other device must know the encryption key 115 and the state of the encryption state variables 114. The encryption logic 113 may be implemented as a software module executed by a microprocessor or be implemented as logic circuit in an FPGA or ASIC.

In some embodiments, the encryption algorithm may be a rotor-based encryption algorithm and the encryption state variables 114 may be the rotor settings along with any other variables that influence the state or movement of the rotors. The encryption algorithm implemented by the encryption logic may have the property of data dependence and/or error propagation. Any encryption algorithm that uses a symmetric key and encryption state variables may be used. The term encryption state variable is used to signify the state of the encryption logic and does not necessarily imply that the values are stored in memory or other registers. A block cipher or any permutation may be used as a substitute for the rotor.

Rotor-based encryption schemes can be implemented in hardware with fewer gates and are computationally faster than full-scale block ciphers. The rotor based encryption scheme may also make use of a scaled-down block cipher. While these features make rotor-based encryption preferable in highly constrained devices such as RFID tags, the system and method of secure identification and authentication described herein are not limited to the use of rotor-based encryption algorithms.

The first device 110 may also contain initialization logic 116 that is used to generate a unique response when the first device 110 is queried. This unique response provides a defensive measure against tracking attacks or replay attacks. The initialization logic 116 may use a linear feedback shift register (LFSR), counter, a random number generator, or some other fixed value, varying value or random value generator to generate an initialization vector 117. In some embodiments, the initialization vector 117 may be used in an initialization routine that is used to randomize the encryption state variables. For example, in a rotor-based encryption scheme the initialization vector may be used as the initial rotor settings, or if the initialization vectors word length is too short to fill the initial rotor settings, the initialization vector may be zero padded or duplicated to obtain the correct word length for the initial rotor settings. The initialization routine may also cycle the rotors by encrypting the initial rotor settings, or a combination thereof, in order to randomize the rotor settings. This initialization routine should be able to be duplicated by the second device 120.

The initialization logic 116 may also use an identifier such as a session ID that is received from a querying device to generate an initialization vector. In an RFID tag embodiment, the initialization logic may be implemented as an LFSR that is clocked when the tag is powered up to respond to a command from a reader or under normal tag operating procedures. With passive RFID tags, the clocked LFSR state may then be stored in non-volatile memory on the RFID tag and reloaded into the LFSR upon receipt of another query.

The first device 110 may also contain processing logic 118 that is used to control the operation of the device. This may include controlling the initialization logic, controlling the encryption logic, controlling the communications and other functions for implementing the authentication system that will be described later with respect to the method. The processing logic 118 may be implemented as a software module executed by a microprocessor or be implemented as logic circuit in an FPGA or ASIC.

The second device 120 contains encryption logic 123 that uses the same encryption algorithm as the first device. The second device 120 receives the encryption state variables 114 from the first device 110 and stores it as the encryption state variables 124 within the second device 120. In some embodiments, the first device 110 may also encrypt the encryption state variable 114 using the encryption key 115 or another secret key shared between the two devices. For example, the encryption key or secret key could be used to obfuscate the encryption state variables 114 by performing modular 2 or modular 2ⁿ addition with the key and the encryption state variables 114.

The second device 120 has secure access to a key database 129 that stores all of the symmetric keys for all known devices. For example, in an RFID embodiment the RFID tag reader would have access to a secure key database that holds the encryption key used by all known RFID tags within the system. The key database 129 may be located within the second device 120 or securely connected to the second device 120 so that data within the key database 129 will not be revealed to an attacker.

The key database 129 will contain the symmetric key for all known devices and may also contain values related to the encryption state variables for each device. If a secret key is used to encrypt the encryption state variables 114 then this key may also be stored in the key database 129. After the second device 120 has recovered the encryption state variables, the key database 129 may be searched using the recovered encryption state variables and a match will be found if the two devices are synchronized. The key database 129 may be sorted by the encryption state variables, or using a hash of the encryption state variables to allow for quicker searching.

The second device 120 may also contain processing logic 128 that is used to control the operation of the device. This may include controlling the encryption logic, controlling the communications and other functions for implementing the identification and authentication system that will be described later with respect to the method. The processing logic 128 may be implemented as a software module executed by a microprocessor or be implemented as logic circuit in an FPGA or ASIC.

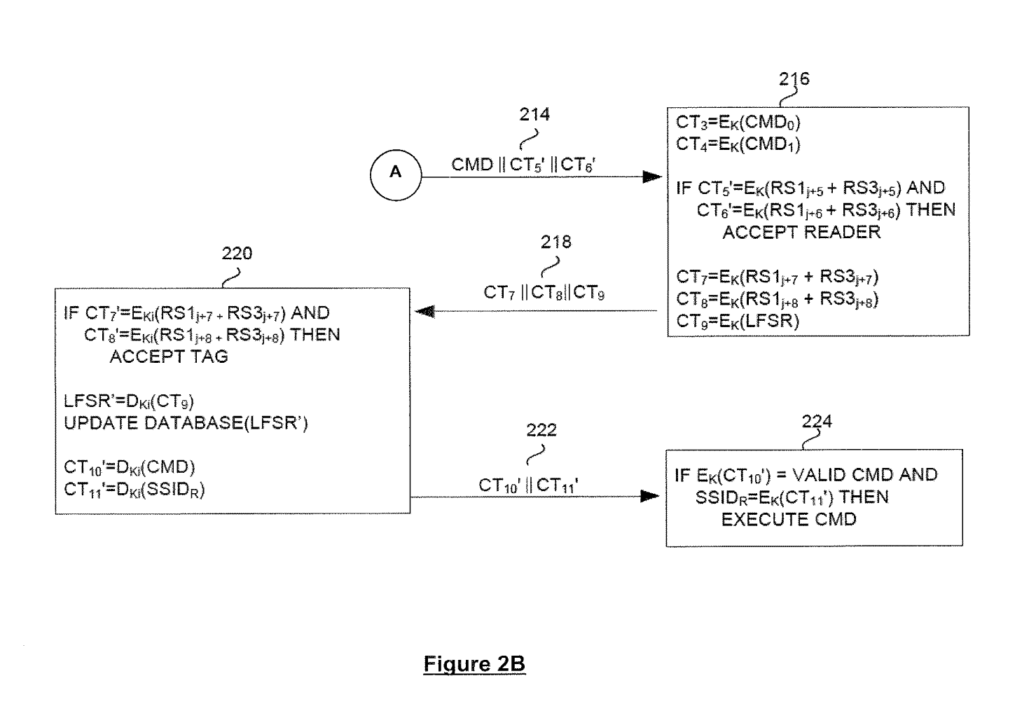

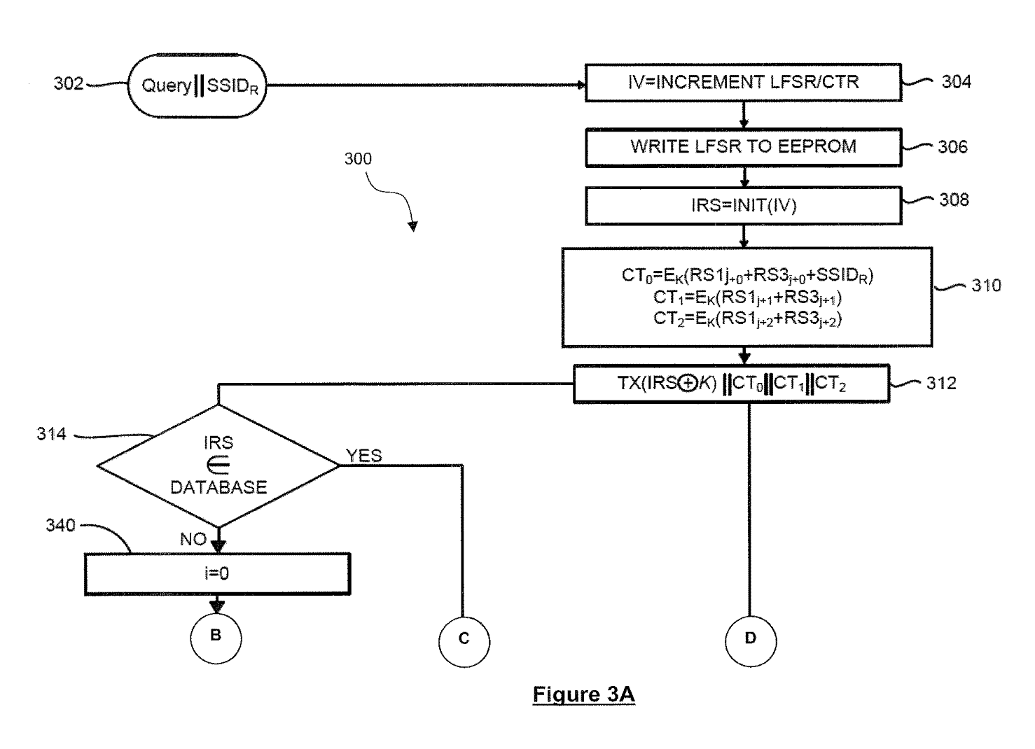

Now referring to FIG. 2, shown is a protocol diagram 200 for a synchronized mutual authentication and identification method. The embodiment shown in FIG. 2 demonstrates the authentication method using an RFID tag 202 and an RFID Reader 204. The RFD Reader 204 initiates the method by transmitting an query 206 to the RFID tag 202. The query 206 may also be accompanied by a unique identifier, such as a session identifier, that may be used in the initialization routine of the RFID tag 202.

Upon receipt of the query 206, the RFID tag 202 begins an initialization step 208. The initialization step 208 creates a unique response to each query by generating an initialization vector (IV) from a linear feedback shift register (LFSR) or counter. This step makes it highly probable that the RFID tag 202 will have a unique response to the query 206. In RFID embodiments this may involve loading the counter or LFSR with a value from non-volatile memory when the RFID tag powers up and clocking the LFSR or counter to generate the initialization vector. This clocked value is then stored in non- volatile memory to be used the next time the RFID tag is queried.

The initialization step 208 also sets the initial values for any encryption state variables used by the encryption algorithm. In the embodiment shown in FIG. 2, a rotor-based encryption algorithm is used where the initial rotor settings (IRS) used by the algorithm are configured according to the initialization vector (IV). The IV may go through a further initialization routine in order to arrive at a state that is unique and unpredictable, as described above with respect to the initialization logic 116, in order to further randomize the IRS.

Once the encryption state variables have been initiated, the encryption algorithm may then be used to generate a set of indicator values that will identify the device. In the embodiment shown in FIG. 2, these indicator values are represented as the cipher texts CT₀, CT₁ and CT₂ which are generated by encrypting the sum of RS1+RS3, where RS1 and RS3 are rotor settings 1 and 3 of the encryption algorithm. Similarly, in a block cipher approach, the state variables may be used in some manner as input to the encryption algorithm to generate the cipher text.

The index j+X is used to indicate the X^{th} iteration of the encryption algorithm after initialization and reflect the changing rotor settings for each iteration. By using internal variables, such as an encryption state variable or rotor settings, the receiver will be able to duplicate the encryption process to generate the indicator values if the same encryption state variables and symmetric encryption key are used. In embodiments where a session identifier is transmitted to the tag, the identifier may also be used to generate the indicator values. For example, in FIG. 2, CT₀ is generated using the rotor settings and the session ID (SSID).

After the indicator values have been generated, the RFID tag 202 transmits the encryption state variables and the indicator values to the RFID reader 204 as shown in step 210. The encryption state variables, or initial rotor settings in the embodiment shown in FIG. 2, may be obfuscated using a secret key K that is shared between the tag and reader. The key K may be a separate key from the encryption key that drives the encryption algorithm.

The RFID reader 204 is able to begin the authentication method immediately after receiving the encryption state variables and prior to receiving the tag indicators. If the reader and tag are synchronized a value related to the encryption state variables will be within the key database. The value related to the encryption state variables may be the initial rotor settings as shown in step 212, or other embodiments may use any one of or combination of: the initialization vector; a subset of initial rotor settings used to generate indicator values; the encrypted initial rotor settings; and the indicator values themselves. In step 212 the reader determines if the IRS is a member of the key database. If the RFID tag has been identified, the encryption algorithm will be configured to use the encryption state variables and the symmetric encryption key for the identified RFID tag 202.

Although the tag has been identified, as additional security, the reader may generate tag indicators similar to steps performed by the tag to verify that the tag indicators received by the reader are the same. Performing this step may also be necessary to synchronize the encryption state variables between the tag and reader. Alternatively, the synchronized encryption state variables may be stored in the database.

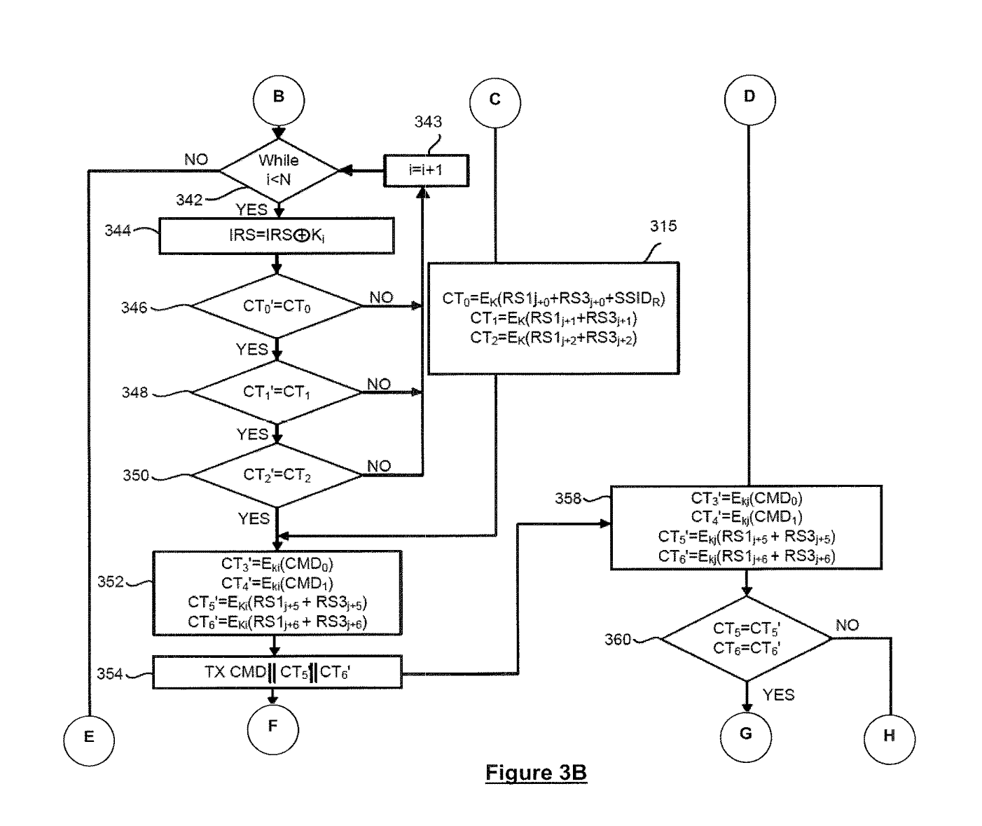

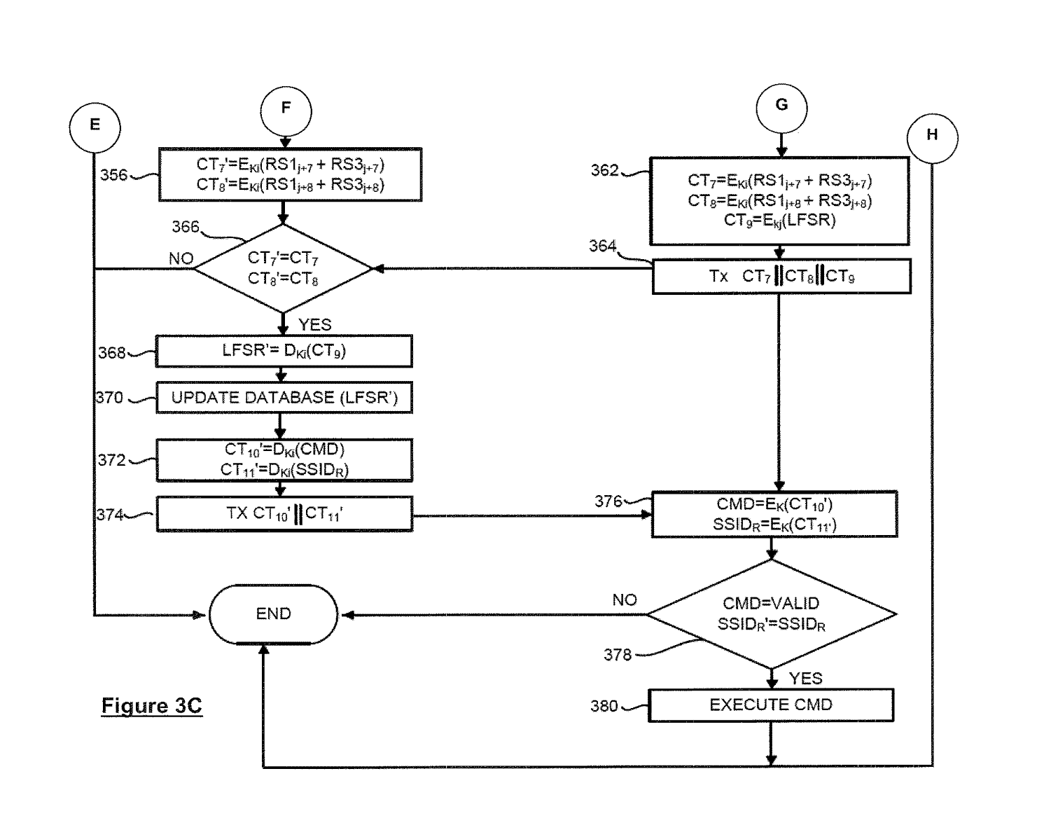

If the tag and reader are out of synchronization then the encryption state variables will not be present within the key database and the reader must perform an exhaustive search of all the keys in the database. For each key in the database the reader will recover the received encryption state variables and then use the encryption state variables to generate indicator values in the same manner that the tag used in step 208. If the generated indicator values match those received by the reader then the key has been identified. The key search process is described in more detail with respect to the process flow shown in FIG. 3.

After the tag has been identified it should be challenged to make sure the tag's response to the query was simply not a replay of a previous broadcast. In step 212, the reader 204 will generate a random challenge command and then encrypt the command. If an encryption algorithm has the property of data dependence then a derivative of the challenge command may be produced by encrypting the encryption state variables. The result may be thought of as a hash of the challenge command. In the embodiment shown in FIG. 2, the challenge command, comprised of CMD_{O} and CMD₁, is encrypted causing the rotor settings to advance. These rotor settings are related to the previous rotor settings and challenge command. The sum of the rotor settings are then encrypted to generate indicator values CT₅′ and CT₆′.

The challenge command and the indicator values are transmitted to the tag 202 in step 214. Upon receiving the challenge command and indicator values, the tag 202 performs the same operation upon the challenge command as the reader 204 performed in step 212. These steps are carried out in step 216 in the embodiment shown in FIG. 2. The tag 202 will authenticate the reader 204 if the encrypted encryption state variables are equal to the indicator values received from the tag 202. If the reader 204 is accepted then the reader may generate further indicator values, shown as CT₇ and CT₈, and encrypt the initialization vector, shown as CT₉. The indicator values and the encrypted initialization vector are then transmitted to the reader 204 in step 218.

In step 220 the reader 204 performs operations similar to tag 202 in step 216 to generate the indicator values. Step 220 may be performed by the reader immediately after step 212 in anticipation of the response from the tag 202. If the indicator values received match those generated by the reader 204 then the tag may be authenticated. To synchronize the tag 202 and reader 204, the reader 204 may decrypt the received initialization vector and store this value in the key database. As shown in FIG. 2, the UPDATE DATABASE function is passed the received LFSR value as a parameter. In some embodiments, the UPDATE DATABASE function may use the received initialization vector to generate the encryption variables that will be used by the tag next time it is queried. In addition, the function may encrypt the encryption variables in the same manner that the tag would after being queried and store the encrypted encryption variables in the key database to allow faster lookups. As described above, there are a number of possible values related to the encryption state variables that may be stored in the database and the initialization vector and LFSR are provided by way of example only.

Upon the completion of step 220, the tag 202 should be ready to accept any command besides a challenge command. In order to prevent the insertion of an unwanted command by an attacker, the tag 202 should authenticate any commands it receives. This may be accomplished by encrypting each command sent to the tag 202 by the reader. In the RFID embodiment shown in FIG. 2, the tag 202 may be limited by power and size limitations such that it only has the encryption functionality. In this embodiment a reader may implement a decryption function to obfuscate the command from an attacker that may then be recovered by the tag 202 using the inverse operation, which is the encryption function. In other embodiments a session identifier may be transmitted along with the command for added authentication by the receiving tag. The session identifier may be similarly decrypted so that the tag may recover the session identifier by the encryption operation. Another option for command authentication includes padding the command with extra bits for added authentication so that when the tag receives the command it can confirm that the padded bits match the accepted padding format.

Step 222 shows the decrypted command and session identifier being transmitted to the tag 202. In order to recover the command and session identifier, the tag 202 then performs the encryption operation on the command and session identifier in step 224. If the command is valid, it may then be executed by the tag 202.

Now referring to FIG. 3, shown is a process flow 300 of a synchronous embodiment. An RFID reader may transmit a query and session identifier to an RFID tag in step 302. The tag may then generate an initialization vector (IV) from an LFSR or counter in step 304. Next, in step 306, the state of the LFSR or counter may be stored in non-volatile memory such as EEPROM. The initialization vector will then go through an initialization routine to randomize the encryption state variables. For example, in step 308 the initial rotor settings (IRS) are configured by passing the initialization vector (IV) to the INIT function.

Next, in step 310, tag indicators that the reader may use to identify the tag are generated. The tag indicators are generated using the encryption algorithm and encryption variables. In the embodiment shown in FIG. 3, rotor setting 1 (RS1) and rotor setting 3 (RS3) are a subset of the initial rotor settings and are encrypted along with the session identifier to generate the cipher text used as tag indicators, CT₀, CT₁ and CT₂.

In step 312, the tag may use a secret key K, which may be a separate key from the encryption key that drives the encryption algorithm, to obfuscate the encryption state variables transmitted over the communication link. The operation may be a modular 2 or modular 2ⁿ addition of the encryption state variables with the key. For example, FIG. 3 shows the IRS XORed with key K

As soon as the reader has received the encryption state variables from the tag it may begin searching the key database to determine if there is a match. If a match is found, the reader and tag are synchronized and the reader encryption algorithm is configured to use the received encryption state variables and the symmetric encryption key from the key database. If the tag and reader are not synchronized then the reader must carry out an exhaustive search of all the keys in the database in order to identify the tag. The process begins by setting the iteration variable i to zero in step 340. Step 342 of the process continues searching the key database while i is less than N, where N is the total number of keys in the key database.

The first step of the key search process is to recover the encryption state variables. In the embodiments shown in FIG. 3, at step 344 the received IRS is XORed with the key Kᵢ, where Kᵢ represents the secret key for the i^{th} tag entry in the key database. The recovered IRS and Kᵢ may then be used with the encryption algorithm.

At step 346 the reader performs the same encryption algorithm on the same variables used by the tag to determine if the correct key entry from the database has been selected. If the tag indicator generated by the reader is equal to the tag indicator received by the reader, shown as CT₀=CT₀ in FIG. 3, then you have potentially selected the correct key. If step 348 and step 350 also succeed, comparing CT₁=CT₁ and CT₂=CT₂ respectively, then the process has probabilistically selected the correct key. Each successive comparison may eliminate candidate keys. Once the correct key has been discovered the tag may be identified using data associated with the correct key in the database. These steps may be performed successively on each tag indicator as it is received and may allow the key search to proceed in parallel with the reception of the tag indicators depending on the implementation.

Some embodiments may be configured to use rotor-based encryption. The rotor-based encryption typically operates on smaller blocks, such as 16-bit blocks, as opposed to a typical block cipher which operates on blocks of 128-bits or greater. Using a rotor-based encryption algorithm allows the reader to eliminate a potential key match more efficiently and quicker than a typical block cipher.

If any of the comparison steps fail, the iteration variable may be incremented at step 343 and the next key in the database may be tested. Most of the candidate keys in the database will fail the comparison tests. Therefore, the cost to eliminate a candidate key in the database is usually only a single encryption operation performed on a small block.

In step 352 the reader generates a random challenge command that is then encrypted. The reader then generates indicators CT₅′ and CT₆′ using the received rotor settings and the encryption key from the key database that pertains to the identified tag. The unencrypted challenge command and the indicators are then transmitted to the tag in step 354. Immediately after generating and encrypting the challenge command, the reader may begin generating the indicators CT₇′ and CT₈′ as shown in step 356.

When the tag receives the challenge command it may begin encrypting the command and then generating tag indicators shown as CT₅ and CT₆ in step 358. The tag indicators generated in step 358 are compared to the tag indicators received from the reader at step 360 of the process. If CT₅=CT₅′ and CT₆=CT₆′ then the tag validates the reader, otherwise the tag terminates its communication with the reader.

The tag then responds to the challenge command with the tag indicators related to the encryption state variables and the state of the initialization vector. For example, in step 362, tag indicators CT₇ and CT₈ are generated by encrypting RS1 and RS3, and CT₉ is generated by encrypting the LFSR. The tag indicators and the initialization vector are then transmitted to the reader in step 364.

Upon receiving the tag indicators, the reader compares whether the previously generated tag indicators from step 356 match the received tag indicators. If the tag indicators match, the reader will accept the tag as being authentic. The received initialization vector may then be decrypted in step 368 and used to update the database in order to synchronize the reader and tag as shown in step 370.

Now that both the tag and reader have been authenticated the tag is ready to accept a command other than a challenge command. To prevent any insertion of unwanted commands from an adversary, the tag may authenticate any command it receives. In the embodiment shown in FIG. 3, the tag only has the encrypt functionality so the reader can perform the decryption function on the command (CMD), and in some embodiments, also decrypt the session identifier (SSID) for greater security as shown in step 372. This will have the effect of encoding or encrypting the command to an attacker. The decrypted command and session identifier may then be transmitted to the tag in step 374.

The tag may then perform the encryption operation on the received tag indicators to recover the command and session identifier, shown in step 376. Next, at step 378, the tag determines whether the command is valid and the correct session identifier was used, if so, then the command will be executed at step 380.

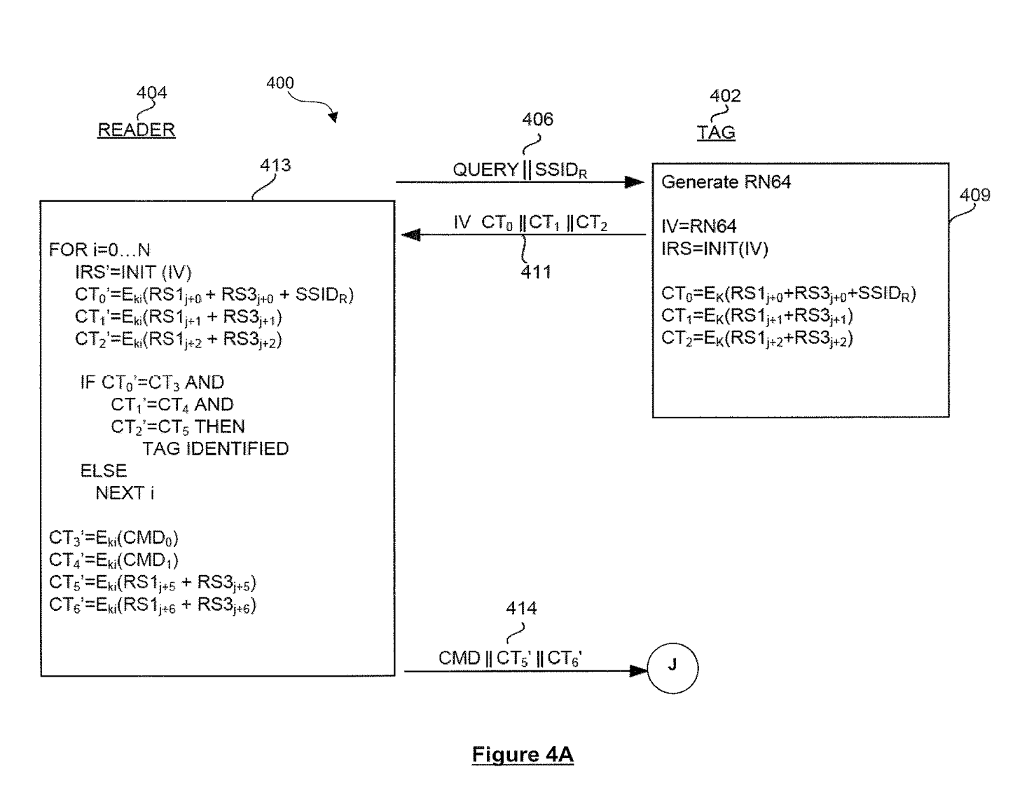

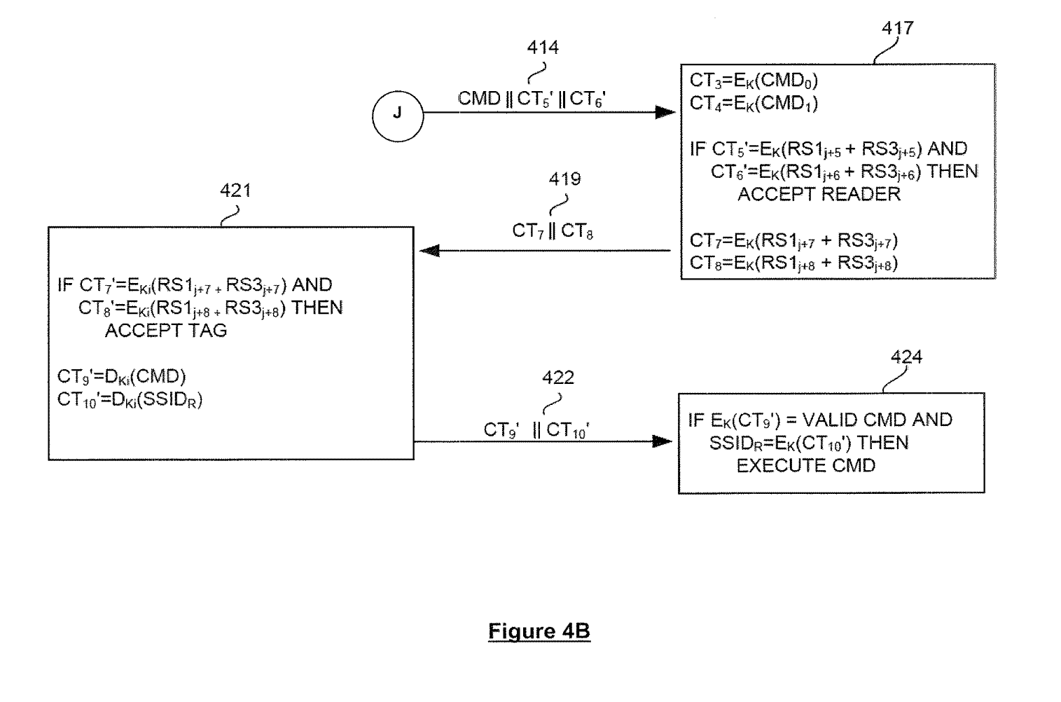

Now referring to FIG. 4, shown is a protocol diagram 400 for a non-synchronous mutual authentication and identification method. In this embodiment the tag 402 may not have non-volatile memory available to store the state of the initialization vector. Since the tag will not be able to save the state of previous sessions, the reader will not be able to synchronize with the tag and the reader will perform an exhaustive key search of the key database for each session. The elements of FIG. 4 retain the numbering scheme of FIG. 2 where the non-synchronous and synchronous protocols are similar.

In order to prevent tracking attacks the tag 402 should generate a unique response to the query 406. Tag 402 may use any number of methods for generating a random response, for example, in FIG. 4, a 64-bit random number (RN64) may be output from an onboard pseudo-random number generator. The random number may then be used as the initialization vector. The initialization of the encryption algorithm and generation of the indicator values in steps 409 then proceeds similarly to step 208 in the embodiment shown in FIG. 2.

The tag 402 may then transmit encryption state variables and the tag indicators to the reader in step 411. The encryption state variables may be either the rotor settings themselves or the initialization vector from which the encrypt state variables may be derived by following a similar initialization routine as used by the tag.

Upon receiving the encryption state variables and tag indicators the reader must perform an exhaustive key search to identify the tag. In step 413 the reader will initialize the encryption state variables using the received data and begin testing each key similar to step 212 of the embodiment of FIG. 2 when the tag and reader are not synchronized. The remainder of the protocol is similar to that of the embodiment shown in FIG. 2 with the exception of step 417, 419 and 421. These steps no longer require transmitting and storing an initialization vector or encryption state variables in the key database since the tag generates a random response and is not synchronized with the reader.

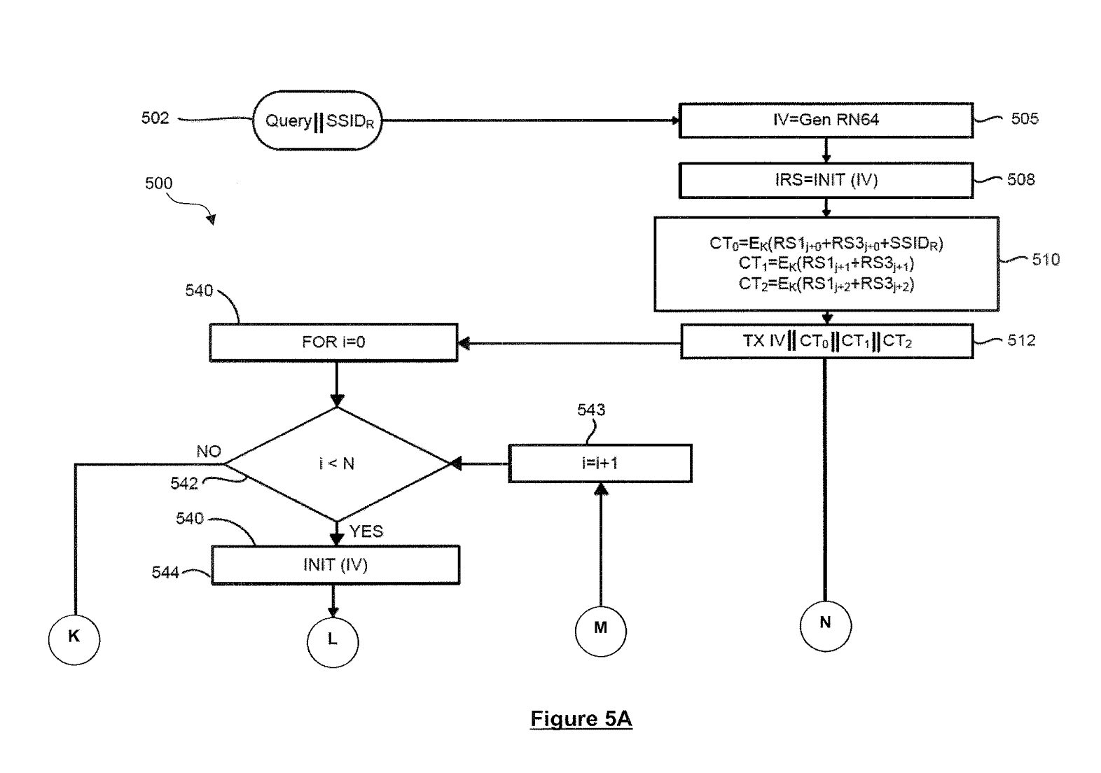

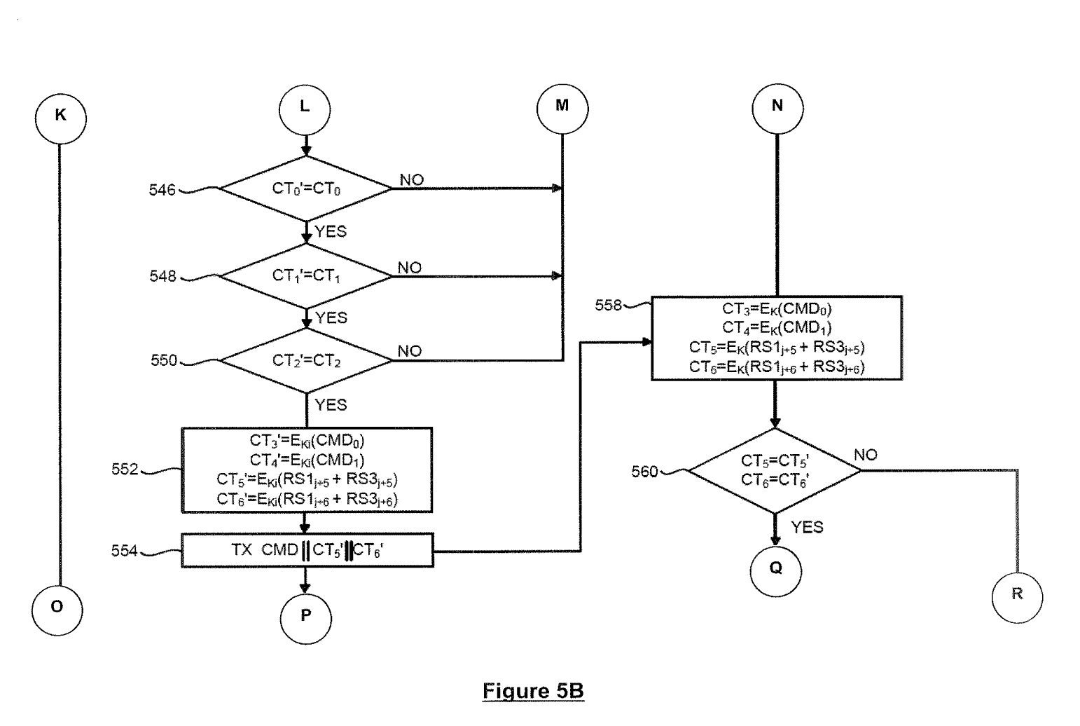

Now referring to FIG. 5, shown is a process flow 500 of a non-synchronous embodiment. The process flow 500 is similar to the process flow for the synchronous approach shown in FIG. 3 except for the steps dealing with the key database and the initialization vector. The elements of FIG. 5 retain the numbering scheme of FIG. 3 where the non-synchronous and synchronous protocols are similar. In the process flow 500 of the non-synchronous approach the initialization vector is generated from a pseudo random number generator in step 505. Upon receiving the initialization vector and tag indicators, the reader must perform an exhaustive search of the key database in steps 540 through 550.

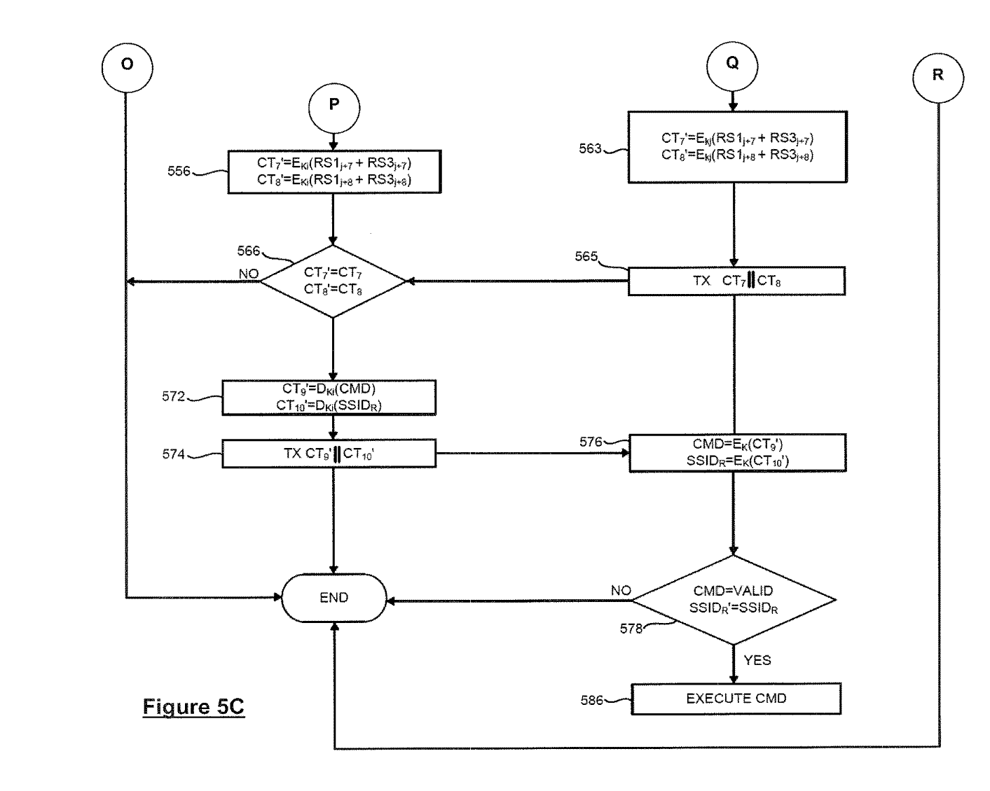

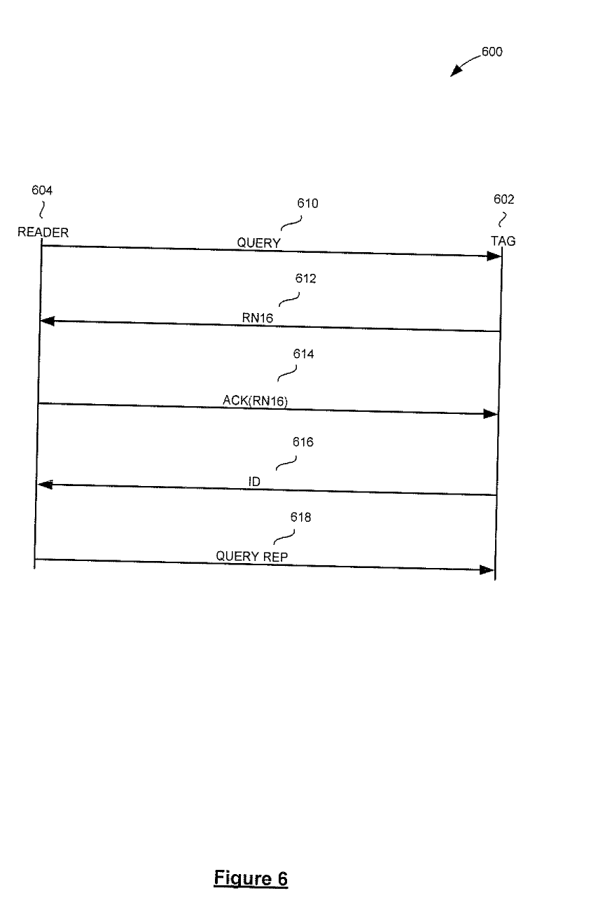

Now referring to FIG. 6, shown is an implementation of an unsecure identification protocol. The protocol 600 is similar to that used in the ECP Global Gen 2 standard for RFID tags. The protocol 600 begins with a reader 604 sending a query to a tag 602 in step 610. The tag 602 may then respond with a 16-bit random number that is generated by the tag 602, this is shown in step 612 where RN16 is the 16-bit random number. Next, in step 614, the reader 604 acknowledges the tag by issuing an acknowledge command with the same 16-bit random number from the tag. The tag 602 may then respond with the electronic product code (EPC) or other information identifying the tag 602 as shown in step 616. In the EPC Global Gen 2 standard this identification information is transmitted in the clear. An attacker may intercept this identification information and use it to trace the location of the particular tag or use the information to create a clone of the tag. In step 618, the tag is in an open state and may respond to a number of commands.

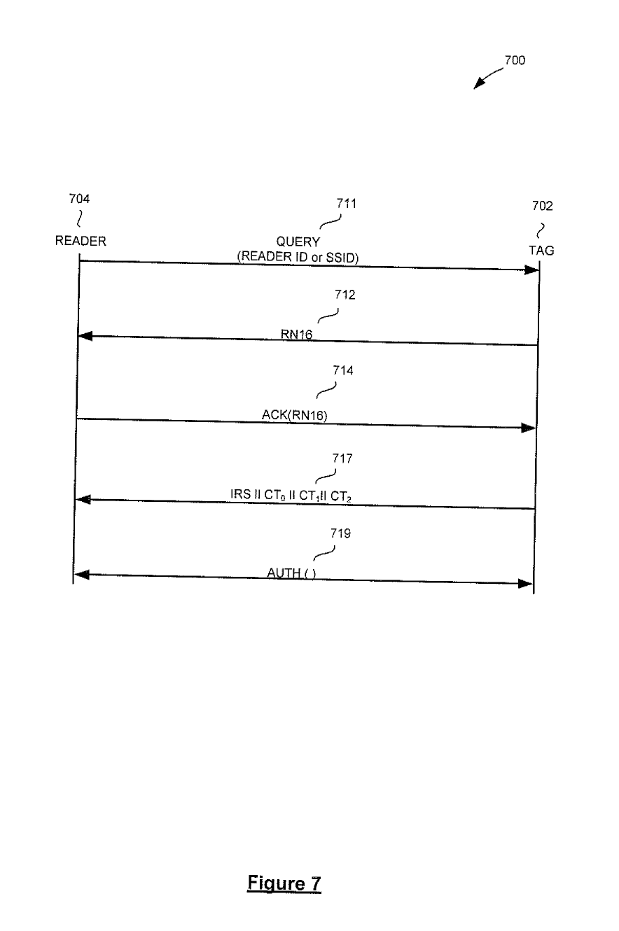

Now referring to FIG. 7, shown is an embodiment integrated within a common RFID protocol. The mutual authentication and identification methods described above with respect to FIGS. 1-4 may be integrated into the EPCglobal Gen 2 standard as shown in protocol 700. The above-described methods may have other communications interleaved from the Gen 2 standard and may also use the commands of the standard to carry out the parts of the protocol.

In the protocol shown in FIG. 7, the reader 704 initiates the protocol by sending the Query command shown in step 711 to the tag 702. The Query command may also contain data such as reader identification information or session identification information. Similar to steps 612 and 614 in FIG. 6 of the Gen 2 standard, the tag 702 responds with a 16-bit random number and the reader 704 acknowledges by returning the 16-bit random number. The tag may use the same LFSR or PRNG that is used to generate the initialization vector to generate the 16-bit random number.

After sending the 16-bit random number, the tag 702 may then initialize the encryption state variables and generate the tag indicators as described above. The generation of tag indicators may use the information transmitted by the reader with the Query command such as a session identifier or reader identifier. The 16-bit random number generated in response to the Query command may also be used in the generation of the tag indicators.

Instead of sending identification information in the clear, the tag 702 may now transmit the rotor settings or value from which the rotor settings may be derived, such as the IRS in step 717, along with the generated tag indicators. The EPCglobal Gen 2 standard provides for protocol control and extended protocol words that may be used for this purpose. The reader 704 will then use this information to perform the key lookup according to the above method to identify the tag 702. The identification of the tag is performed in manner that does not allow an attacker know the identity of the tag or to trace the tag.

In step 719, the reader and tag may now perform mutual authentication according to the above-described methods.

The present invention has been described here by way of example only. Various modification and variations may be made to these exemplary embodiments without departing from the spirit and scope of the invention, which is limited only by the appended claims.

We claim:

1. A method of securely identifying devices and authenticating communications between a first device and a second device in a symmetric encryption system, each device having encryption state variables, the method comprising:
receiving encryption state variables from the first device at the second device;
for each encryption key in a key database of the second device, generating an indicator using the received encryption state variables; and
comparing the generated indicator to an indicator received from the first device to identify the first device by the encryption key used.

2. The method of claim 1 further comprising:
determining at the second device if the received encryption state variables relate to an encryption key in the key database of the second device.

3. The method of claim 2 further comprising:
generating an initialization vector at the first device in response to a query;
initializing the encryption state variable of the first device using the initialization vector; and
generating the indicator using the encryption state variables of the first device.

4. The method of claim 3, wherein the initialization vector is generated from any one of a LFSR, a counter or a random number generator.

5. The method of claim 3, wherein the query contains an identifier that is used to generate the initialization vector.

6. The method of claim 3, wherein the query contains an identifier that is used to generate the indicator.

7. The method of claim 3 further comprising:
generating a challenge command at the second device;
encrypting the challenge command using the encryption state variables;
generating a second indicator at the second device by using the encryption state variables of the second device; and
transmitting the challenge command and the second indicator to the first device.

8. The method of claim 7 further comprising:
receiving the challenge command and the second indicator at the first device;
encrypting the challenge command at the first device; and
validating the second device if the received second indicator matches an indicator generated at the first device using the encryption state variables of the first device.

9. The method of claim 8, further comprising:
generating a third indicator at the first device using the encryption state variables of the first device;
encrypting the initialization vector of the first device; and
transmitting the third indicator and initialization vector to the second device.

10. The method of claim 9 further comprising:
generating a third set of indicator values at the second device using the encryption state variables of the second device; and
validating the first device if the received third indicator matches an indicator generated at the second device using the encryption state variables of the second device.

11. The method of claim 10 further comprising storing the received initialization vector in the key database of the second device.

12. The method of claim 10, wherein the encryption state variables are related to encrypted data.

13. The method of claim 12, wherein the encryption state variables are rotor settings of a rotor-based encryption scheme.

14. The method of claim 10, wherein the first device is an RFID tag and the second device is an RFID reader.

15. A system for securely authenticating communications in a symmetric encryption system, the system comprising:
a first device having encryption state variables, the first device comprising:
a transmitter for transmitting encryption state variables and indicators;
a second device having encryption state variables, the second device comprising:
a receiver for receiving encryption state variables from the first device;
a key database for storing encryption keys;
encryption logic for generating indicators using the received encryption state variables and encryption keys from the key database; and
processing logic for comparing generated indicator values to received indicator values to identify the first device by the encryption key used.

16. The system of claim 15, wherein the processing logic determines if received encryption state variables are within the key database.

17. The system of claim 15, wherein the first device further comprises:
initialization logic for generating an initialization vector in response to a query and initializing the encryption state variables; and
encryption logic for generating indicator values using the encryption state variables.

18. The system of claim 17, wherein the initialization logic is comprised of any one of a LFSR, a counter or a random number generator.

19. The method of claim 17, wherein the query contains an identifier that is used to generate the initialization vector.

20. The method of claim 17, wherein the query contains an identifier that is used to generate the indicator.

21. The system of claim 17, wherein the second device further comprises:
a transmitter for transmitting a random challenge command generated by the processing logic and a second indicator generated by the encryption logic by encrypting the encryption state variables of the second device.

22. The system of claim 21, wherein the first device further comprises:
a receiver for receiving the challenge command, the query and the second indicator;
processing logic for validating the second device if the received second indicator matches an indicator generated using the encryption state varaiables.

23. The system of claim 22, wherein the transmitter of the first device transmits a third indicator generated by the encryption logic using the encryption state variables; and the transmitter transmits the initialization vector encrypted by the encryption logic.

24. The system of claim 23, wherein the processing logic of the second device validates the first device if a received third indicator matches an indicator generated using the encryption state variables.

25. The system of claim 24, wherein the key database of the second device stores the received initialization vector related to the first device.

26. The system of claim 24, wherein the encryption state variables are related to encrypted data.

27. The system of claim 26, wherein the encryption state variables are rotor settings of a rotor-based encryption scheme.

28. The system of claim 24, wherein the first device is an RFID tag and the second device is an RFID reader.

29. A method for securely identifying and authenticating communications between a first device and a second device in a symmetric encryption system, the method comprising:
first, providing secure identification from the first device to the second device; and
second, providing secure authentication between the first device and the second device.

30. The method of claim 29 wherein the step of providing secure identification comprises:
generating an indicator using encryption state variables of the first device;
transmitting the encryption state variables and the indicator to the second device;
at the second device, for each encryption key in a key database, comparing an indicator generated using the encryption key and the received encryption state variables to the indicator received from the first device.

31. The method of claim 30 wherein the first device and second device are RFID devices.

32. The method of claim 31 wherein the steps of providing secure identification and secure authentication is integrated into the an RFID standard.

33. The method of claim 32 wherein the RFID standard is the EPCGlobal Gen 2 Standard.

34. The method of claim 33 wherein the step of providing secure identification may be provided as the identification step of EPCGlobal Gen 2 standard.
